(19) United States
(12) Patent Application Publication
(10) Pub. No.: US 2015/0271883 A1
(43) Pub. Date: Sep. 24, 2015

(54) POWER SUPPLY DEVICE

(71) Applicants: SAMSUNG ELECTRO-MECHANICS CO., LTD., Suwon-Si (KR); KOREA ADVANCED INSTITUTE OF SCIENCE AND TECHNOLOGY, Daejeon (KR)

(72) Inventors: Jae Kuk KIM, Suwon-Si (KR); Jae Hyun Kim, Daejeon (KR); Jae Bum Lee, Daejeon (KR); Gun Woo Moon, Daejeon (KR); Dong Kyun Ryu, Suwon-Si (KR)

(73) Assignees: SAMSUNG ELECTRO-MECHANICS CO., LTD., Suwon-Si (KR); KOREA ADVANCED INSTITUTE OF SCIENCE AND TECHNOLOGY, Daejeon (KR)

(21) Appl. No.: 14/585,980

(22) Filed: Dec. 30, 2014

(30) Foreign Application Priority Data
Mar. 19, 2014 (KR) 10-2014-0032169

(51) Int. Cl. H05B 33/08

(52) U.S. Cl. CPC H05B 33/0815

(57) ABSTRACT

A power supply device may include a switching unit receiving and switching direct current power to provide power, a converting unit converting primary power into secondary power having a voltage level depending on a preset turns ratio according to the switching of the switching unit and outputting the converted secondary power, a light emitting diode which is driven by the secondary power provided from the converting unit, and a controlling unit generating a control signal of the switching unit based on voltage information of the secondary power and current information from the light emitting diode.

### CROSS-REFERENCE TO RELATED APPLICATION

This application claims the benefit of Korean Patent Application No. 10-2014-0032169 filed on Mar. 19, 2014, with the Korean Intellectual Property Office, the disclosure of which is incorporated herein by reference in its entirety.

### BACKGROUND

The present disclosure generally relates to a power supply device.

Conventionally, a direct current to direct current (DC/DC) converter has been used as a power device in a variety of electronic products such as computers, display devices, and the like.

Such a DC/DC converter may provide a plurality of levels of output power, depending on the electronic product in which it is used. The power device using a multi-output DC/DC converter has continuously been developed.

For example, a dual-feedback DC/DC converter may simultaneously regulate two outputs (e.g., an audio voltage V_{A} and a light emitting diode (LED) current I_{LED}) by controlling a duty ratio and a switching frequency in a single converter.

In the case in which a controller of the dual-feedback DC/DC converter is configured in an analog scheme, complexity and a size of the controller may be increased.

Instead of such a controller of the analog scheme, a controller of a digital scheme using a micro controlling unit (MCU) may be used.

However, in the case in which a conventional proportional and integration control is performed in the digital scheme, it may be difficult to secure a higher bandwidth than that of the analog control scheme, due to a sample and hold delay, and a computation delay in a dynamic situation in which a load current changes rapidly. Consequently, in the case of using the controller of the digital scheme, dynamic characteristics of the respective outputs of a system may be deteriorated.

Therefore, there is a need to introduce a power supply device employing a controlling scheme capable of improving dynamic characteristics.

### RELATED ART DOCUMENT

### Patent Document

(Patent Document 1) Korean Patent Laid-Open Publication No. 10-2005-0017528

### SUMMARY

An aspect of the present disclosure may provide a power supply device employing a controlling scheme capable of improving dynamic characteristics.

According to an aspect of the present disclosure, a power supply device may include: a switching unit receiving and switching direct current power to provide primary power; a converting unit converting primary power into secondary power having a voltage level depending on a preset turns ratio according to the switching of the switching unit and outputting the converted secondary power; a light emitting diode which is driven by the secondary power provided from the converting unit; and a controlling unit generating a control signal of the switching unit based on voltage information of the secondary power and current information from the light emitting diode.

The controlling unit may include: a frequency controller determining a switching frequency of the control signal; and a duty controller determining a switching duty of the control signal.

The frequency controller may determine the switching frequency of the control signal based on the current information from the light emitting diode, reference current information, and/or the secondary voltage information.

The frequency controller may include: a proportional integral (PI) controlling module performing a PI control for current error information according to the current information from the light emitting diode and the reference current information; and a feed-forward controlling module performing a feed-forward control for an output of the PI controlling module and the secondary voltage information.

The frequency controller may include a switching frequency determining module performing pulse frequency modulation based on an output of the feed-forward controlling module.

The duty controller may determine the switching duty of the control signal according to the secondary voltage information and reference voltage information.

The duty controller may include: a PI controlling module performing a PI control for voltage error information according to the secondary voltage information and the reference voltage information; and a feed-forward controlling module performing a feed-forward control for an output of the PI controlling module and the secondary voltage information.

The duty controller may include a switching duty determining module performing pulse width modulation based on an output of the feed-forward controlling module.

The switching unit may include a first switching element and a second switching element, and the first switching element and the second switching element may be configured to alternately switch on or off, according to the control signal of the controlling unit.

According to another aspect of the present disclosure, a power supply device may include: a power supplying unit outputting first power and second power which are preset by switching input power; and a controlling unit receiving a feedbacked output state of the first power to control switching of the power supplying unit in a first scheme which is preset, according to an output state of the second power, and receiving a feedbacked output state of the second power to control switching of the power supplying unit in a second scheme. The second scheme may be preset differently from the first scheme.

The first power may be secondary current information from the power supplying unit and the second power may be secondary voltage information from the power supplying unit.

The first scheme may be pulse frequency modulation and the second scheme may be pulse width modulation.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a block diagram of a power supply device according to an exemplary embodiment in the present disclosure;

FIG. 2 is a circuit diagram of the power supply device according to an exemplary embodiment in the present disclosure;

FIG. 3 is a diagram schematically illustrating a switching waveform used for an LLC resonance type DC/DC converter according to an exemplary embodiment in the present disclosure;

FIG. 4 is a diagram illustrating a frequency controller according to an exemplary embodiment of the present disclosure;

FIG. 5 is a diagram illustrating a duty controller according to an exemplary embodiment of the present disclosure;

FIGS. 6A through 6C illustrate a waveform illustrating output information according to load variations of a power supply device employing an existing PI controller; and

FIGS. 7A through 7C illustrate a waveform illustrating output information according to load variations of the power supply device according to an exemplary embodiment in the present disclosure.

### DETAILED DESCRIPTION

Hereinafter, embodiments in the present disclosure will be described in detail with reference to the accompanying drawings.

The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art.

Throughout the drawings, the same or like reference numerals will be used to designate the same or like elements.

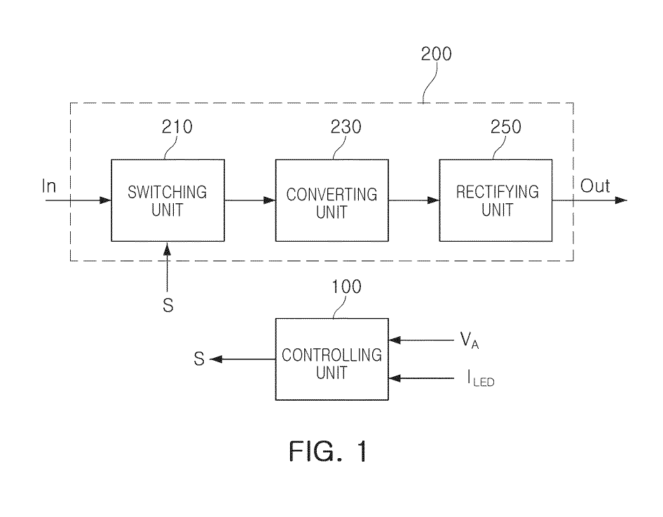

FIG. 1 is a block diagram of a power supply device according to an exemplary embodiment in the present disclosure.

Referring to FIG. 1, the power supply device may include a controlling unit 100 and a power supplying unit 200. The components illustrated in FIG. 1 are not essential components. Therefore, the power supply device may also be implemented with a greater or lesser number of components than the components illustrated in FIG. 1.

The controlling unit 100 may receive a first power I_{LED} and a second power V_{A} which are preset.

The power supplying unit 200 may include a half-bridge LLC resonant converter as illustrated in FIG. 1. However, it may be easily appreciated by those skilled in the art that a configuration according to an exemplary embodiment in the present disclosure described in the present specification may use a flyback converter, a forward converter, a half-bridge converter, a full-bridge converter, a push-full converter, a resonance type converter, or the like.

The power supplying unit 200 may include a transformer having a primary winding and a secondary winding for transforming a voltage level.

A primary circuit unit may be a circuit unit connected to the primary winding of the transformer, and a secondary circuit unit may be a circuit unit connected to the secondary winding of the transformer.

In this case, the first power may be secondary current information from the power supplying unit 200 and the second power may be secondary voltage information from the power supplying unit 200.

The controlling unit 100 may receive a feedbacked output state of the first power and control switching of the power supplying unit 200 in a first scheme which may be preset, according to an output state of the second power.

In addition, the controlling unit 100 may receive a feedbacked output state of the second power and control switching of the power supplying unit 200 in a second scheme, which may be preset, by generating a control signal S. The second scheme may be different from the first scheme.

For instance, the first scheme may be pulse frequency modulation (PFM), and the second scheme may be pulse width modulation (PWM).

The power supplying unit 200 may include a switching unit 210, a converting unit 230, and a rectifying unit 250.

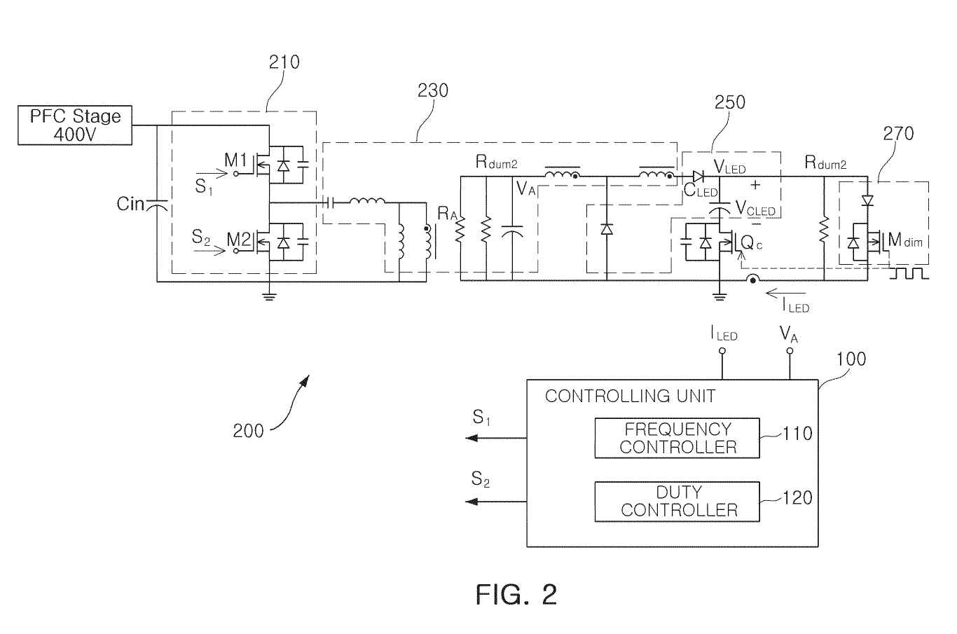

FIG. 2 is a circuit diagram of the power supply device according to an exemplary embodiment in the present disclosure.

Referring to FIG. 2, the power supplying unit 200 may include the switching unit 210, the converting unit 230, and the rectifying unit 250.

The switching unit 210 may include one or a plurality of switching elements, for example, first and second switching elements M1 and M2. The switching unit 210 may receive direct current power from a power factor correction (PFC) unit and may alternately switch power.

The first and second switching elements M1 and M2 of the switching unit 210 may alternately switch on or off, according to control signals S₁ and S₂ from the controlling unit 100.

The converting unit 230 may convert primary power into secondary power having a voltage level depending on a preset turns ratio according to alternate switching of the switching unit 210, thereby outputting the converted secondary power.

The converting unit 230 may include a transformer having a primary winding Nₚ and secondary windings Nₛ₁ and Nₛ₂. In this case, a primary circuit unit may be a circuit unit connected to the primary winding Nₚ of the transformer, and a secondary circuit unit may be a circuit unit connected to the secondary windings Nₛ₁ and Nₛ₂ of the transformer is defined as a secondary circuit unit.

The converting unit 230 may include one or more capacitor elements. In this case, the capacitor element of the converting unit 230 may charge or discharge the power according to the alternate switching of the switching unit 210. For example, the primary circuit unit of the converting unit 230 may include a resonance inductor, a resonance capacitor, and a magnetized inductor of the transformer which may be included in the half-bridge LLC converter.

The rectifying unit 250 may stabilize secondary output power of the converting unit 230 and provide it to a light emitting diode (LED) unit. The rectifying unit 250 may include one or more diode elements and one or more capacitor elements.

The LED unit may include one or a plurality of light emitting diodes which may be connected in series, and the corresponding light emitting diode may perform a light emitting operation with a driving unit 270.

The driving unit 270 may control a drive of the LED unit. For example, the driving unit 270 may perform a dimming control, or the like for the LED unit.

The controlling unit 100 may generate the control signals S₁ and S₂ of the switching unit 210 based on voltage information V_{A} of the secondary circuit unit and current information I_{LED} of the light emitting diode.

The controlling unit 100 may include a frequency controller 110 determining switching frequencies of the control signals S₁ and Sₛ₂, and a duty controller 120 determining switching duties of the control signals S₁ and S₂.

In the case that the controlling unit 100 performs the control in a digital scheme, the controlling unit 100 may include a configuration for converting the voltage information V_{A} of the secondary circuit unit and the current information I_{LED} of the light emitting diode into digital information.

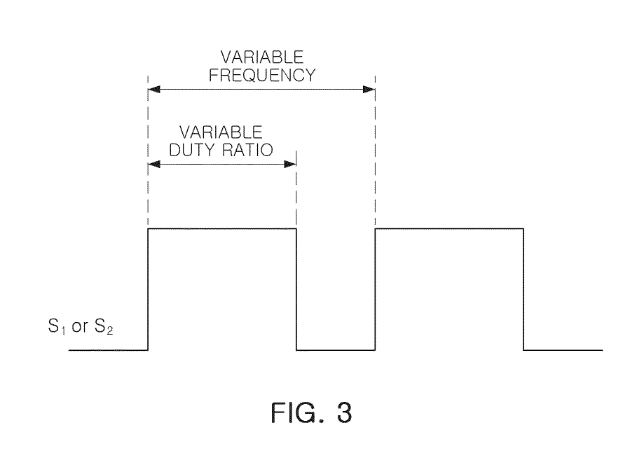

FIG. 3 is a diagram schematically illustrating a switching waveform used for an LLC resonance type DC/DC converter according to an exemplary embodiment in the present disclosure.

As illustrated in an exemplary operation waveform of FIG. 3, as the switching unit 210 is alternately switched, energy may be transferred to the secondary circuit unit. In this case, an output of the secondary circuit unit may be controlled by a variable duty ratio and/or a variable frequency. Preferably, by simultaneously controlling the frequency and the duty ratio, the output of the power supply device may be precisely controlled.

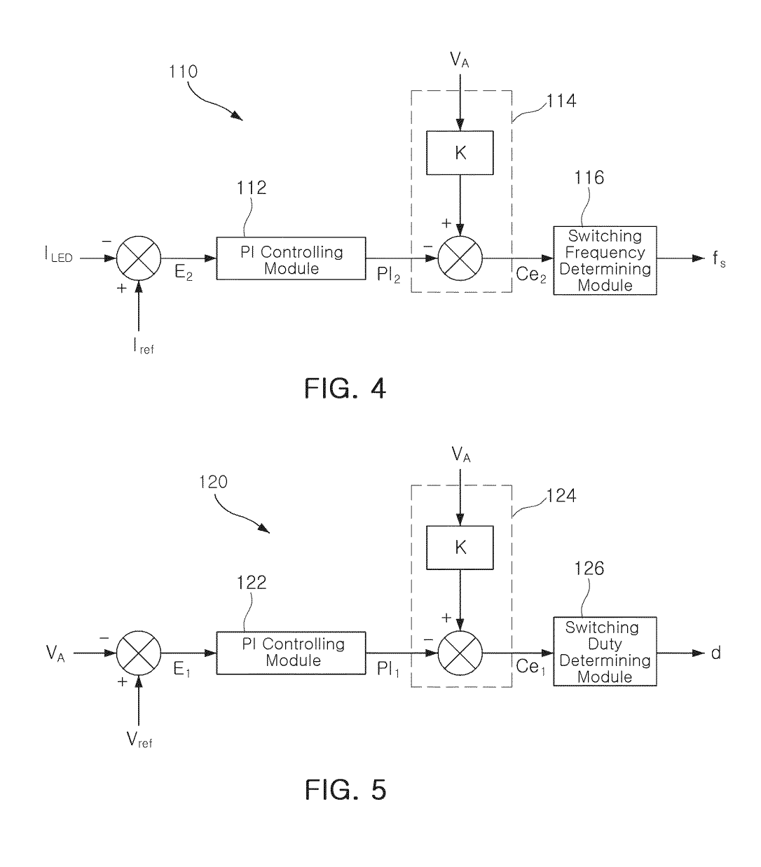

FIG. 4 is a diagram illustrating a frequency controller according to an exemplary embodiment in the present disclosure.

Referring to FIG. 4, the frequency controller 110 may determine a switching frequency of the control signal according to the current information I_{LED} of the light emitting diode, reference current information I_{ref}, and/or the secondary voltage information V_{A}.

The frequency controller 110 may include a proportional integral (PI) controlling module 112, a feed-forward controlling module 114, and a switching frequency determining module 116.

The PI controlling module 112 may perform a proportional integral control for current error information E₂ according to the current information I_{LED} of the light emitting diode and the reference current information I_{ref}. The PI controlling module 112 may correct the current error information E₂ according to the current information I_{LED} of the light emitting diode and/or the reference current information I_{ref}.

The feed-forward controlling module 114 may perform a feed-forward control for an output PI₂ of the PI controlling module 112 and the secondary voltage information V_{A}. In this case, the feed-forward controlling module 114 may appropriately scale the secondary voltage information V_{A} in order to perform the feed-forward control.

The switching frequency determining module 116 may determine the switching frequency based on output information Cₑ₂ of the feed-forward controlling module 114. For example, the switching frequency determining module 116 may perform the pulse frequency modulation (PFM) based on the output information Cₑ₂ of the feed-forward controlling module 114. Therefore, the switching frequency determining module 116 may output frequency information fₛ.

For example, as a level of the current information I_{LED} of the light emitting diode is decreased, a level of the current error information E₂ may be increased. Consequently, a level of the proportional-integral information Cₑ₂ of the PI controlling module 112 may be increased and a level of a calculated result Cᵣ₂ of the proportional-integral information Cₑ₂ of the PI controlling module 112 and the output information from the feed-forward controlling module 114 may be decreased, such that a level of the frequency information fₛ of the switching frequency determining module 116 may be decreased and a level of the current information I_{LED} of the light emitting diode may be increased.

If the level of the secondary voltage information V_{A} is decreased, the level of the calculated result Cᵣ₂ of the proportional-integral information Cₑ₂ of the PI controlling module 112 and the output information from the feed-forward controlling module 114 may be decreased. Consequently, the level of the frequency information fₛ of the switching frequency determining module 116 may be decreased. As a result, the level of the secondary voltage information V_{A} may be increased to, for instance, a predetermined level.

According to an exemplary embodiment in the present disclosure, in the case in which the secondary voltage is varied by the secondary current which may be significantly varied, the frequency controller 110 may perform the control by feed-forwarding the secondary voltage information V_{A} as well as the current information I_{LED} of the light emitting diode. Therefore, the power supply device according to an exemplary embodiment in the present disclosure may have much faster dynamic characteristics than an existing controlling scheme.

FIG. 5 is a diagram illustrating a duty controller according to an exemplary embodiment in the present disclosure.

Referring to FIG. 5, the duty controller 120 may determine a switching duty of the control signal according to the secondary voltage information V_{A} and reference voltage information V_{ref}.

The duty controller 120 may include a PI controlling module 122, a feed-forward controlling module 124, and a switching duty determining module 126.

The PI controlling module 122 may perform a proportional integral control for current error information E₁ according to the secondary voltage information V_{A} and the reference voltage information V_{ref}. The PI controlling module 122 may correct the current error information Eₗ according to the secondary voltage information V_{A} and the reference voltage information V_{ref}.

The feed-forward controlling module 124 may perform a feed-forward control for an output PI₁ of the PI controlling module 122 and the secondary voltage information V_{A}. In this case, the feed-forward controlling module 124 may appropriately scale the secondary voltage information V_{A} in order to perform the feed-forward control.

The switching duty determining module 126 may determine a switching duty based on output information Cₑ₁ of the feed-forward controlling module 124. For example, the switching duty determining module 126 may perform the pulse width modulation (PWM) based on the output information Cₑ₁ of the feed-forward controlling module 124. Therefore, the switching duty determining module 126 may output duty information d.

For example, as a level of the secondary voltage information V_{A} is decreased, a level of the current error information E₁ may be increased. Consequently, a level of the proportional-integral information Cₑ₁ of the PI controlling module 122 may be increased and a level of a calculated result Cᵣ₁ of the proportional-integral information Cₑ₁ of the PI controlling module 122 and the output information from the feed-forward controlling module 124 may be decreased, such that a level of the duty information d of the switching duty determining module 126 may be increased and a level of the secondary voltage information V_{A} may be increased.

The controlling unit 100 may output the control signals S₁ and S₂ based on the frequency information fₛ of the frequency controller 110 and/or the duty information d of the duty controller 120.

Therefore, since the power supply device according to an exemplary embodiment in the present disclosure performs the control by feed-forwarding the secondary voltage information V_{A} as well as the current information I_{LED} of the light emitting diode, it may have much faster dynamic characteristics than an existing controlling scheme.

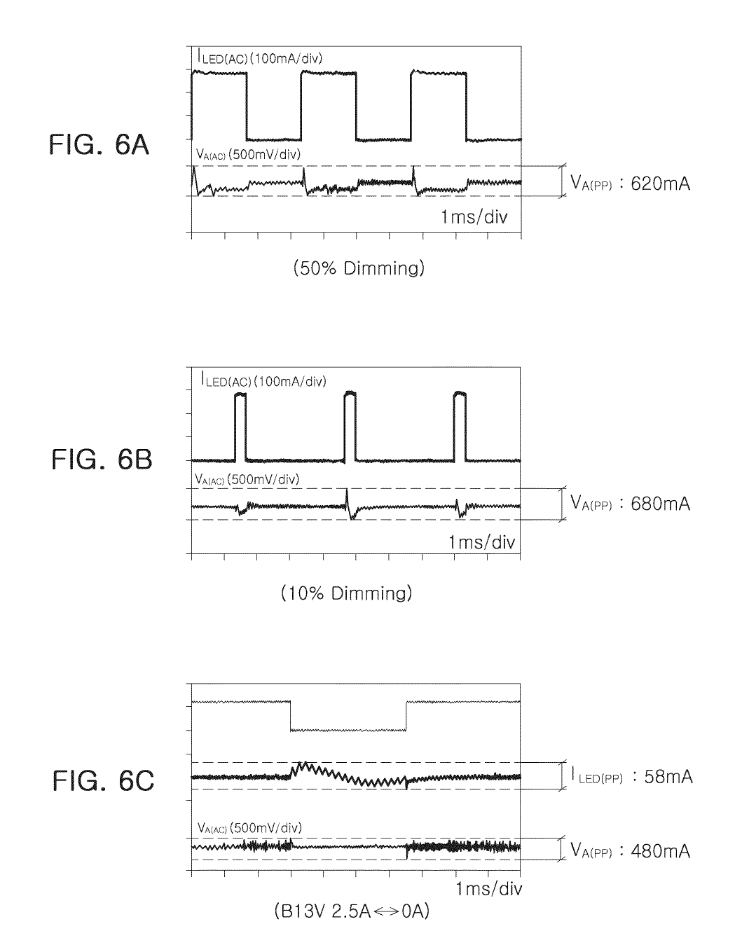

FIGS. 6A-6C illustrate a waveform illustrating output information according to load variations of a power supply device employing an existing PI controller.

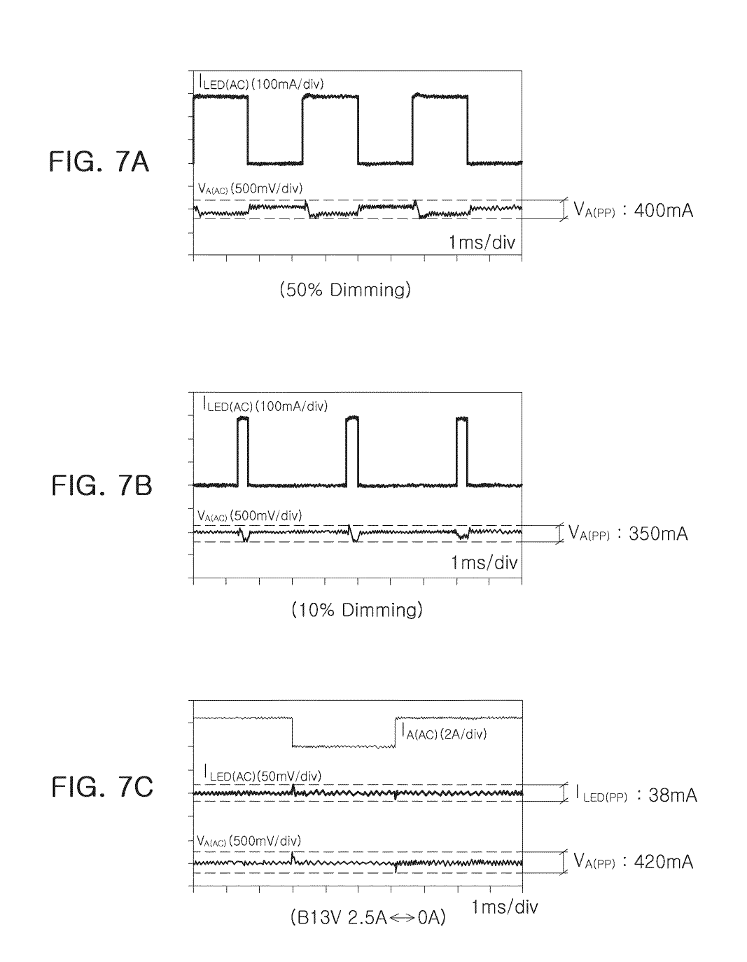

FIGS. 7A-7C illustrate a waveform illustrating output information according to load variations of a power supply device according to an exemplary embodiment in the present disclosure.

In order to check dynamic characteristics of output information according to load variations, the output information is obtained using a multi-output LLC converter for a flat panel display (FPD) of 46 inches.

In the present exemplary embodiment, an input voltage of the DC/DC converter is 400V, an output voltage V_{A} is 12.8V, and an output current is 4.4 A at maximum. In addition, an LED output voltage is 245V and an output current is 289 mA. Output power is 130 W at maximum.

In this case, when the output load is varied, voltage ripple in the output voltage V_{A} is 500 mV at peak-to-peak, and voltage ripple in the output current I_{LED} is 40 mA at peak-to-peak.

FIG. 6A illustrates a waveform illustrating output information in a 50% dimming condition in the power supply device employing the existing PI controller. FIG. 6B illustrates a waveform illustrating output information in a 10% dimming condition in the power supply device employing the existing PI controller. FIG. 6C illustrates a waveform illustrating output information according to load current variations (0 to 2.5 A) in the power supply device employing the existing PI controller.

As shown in FIGS. 6A-6C, it may be confirmed that voltage ripple in the output voltage V_{A} does not satisfy the above-mentioned conditions at the time of LED dimming. In addition, it may be confirmed that the voltage ripple in the output current I_{LED} does not satisfy the above-mentioned conditions when the load current is varied.

FIG. 7A illustrates a waveform illustrating output information in a 50% dimming condition in the power supply device according to an exemplary embodiment in the present disclosure. FIG. 7B illustrates a waveform illustrating output information in a 10% dimming condition in the power supply device according to an exemplary embodiment in the present disclosure. FIG. 7C illustrates a waveform illustrating output information according to load current variation (0 to 2.5 A) in the power supply device according to an exemplary embodiment in the present disclosure.

As shown in FIGS. 7A-7C, voltage ripple in the output voltage V_{A} may satisfy the above-mentioned conditions at the time of an LED dimming. In addition, voltage ripple in the output current I_{LED} may satisfy the above-mentioned conditions when the load current is varied.

That is, the power supply device according to an exemplary embodiment in the present disclosure may improve dynamic characteristics of the respective outputs at the time of load variation as compared to the existing controlling scheme.

In the case in which the controlling method according to an exemplary embodiment in the present disclosure is used for the dual feedback control of a digital scheme, it may secure a higher bandwidth.

As set forth above, according to exemplary embodiments in the present disclosure, the power supply device employing the controlling scheme capable of improving dynamic characteristics may be provided.

While exemplary embodiments have been shown and described above, it will be apparent to those skilled in the art that modifications and variations could be made without departing from the scope of the invention as defined by the appended claims.

What is claimed is:

1. A power supply device comprising:
a switching unit switching direct current power to provide primary power;
a converting unit converting the primary power into secondary power having a voltage level depending on a turns ratio and outputting the secondary power;
a light emitting diode which is driven by the secondary power provided from the converting unit; and
a controlling unit generating a control signal of the switching unit based on voltage information of the secondary power and current information from the light emitting diode.

2. The power supply device of claim 1, wherein the controlling unit includes:
a frequency controller determining a switching frequency of the control signal; and
a duty controller determining a switching duty of the control signal.

3. The power supply device of claim 2, wherein the frequency controller determines the switching frequency of the control signal based on the current information from the light emitting diode, reference current information, and the voltage information of the secondary power.

4. The power supply device of claim 3, wherein the frequency controller includes:
a proportional integral (PI) controlling module performing a PI control for current error information according to the current information from the light emitting diode and the reference current information; and
a feed-forward controlling module performing a feed-forward control for an output of the PI controlling module and the voltage information of the secondary power.

5. The power supply device of claim 4, wherein the frequency controller includes a switching frequency determining module performing pulse frequency modulation based on an output of the feed-forward controlling module.

6. The power supply device of claim 2, wherein the duty controller determines the switching duty of the control signal according to the voltage information of the secondary power and reference voltage information.

7. The power supply device of claim 6, wherein the duty controller includes:
a PI controlling module performing a PI control for voltage error information according to the voltage information of the secondary power and the reference voltage information; and
a feed-forward controlling module performing a feed-forward control for an output of the PI controlling module and the voltage information of the secondary power.

8. The power supply device of claim 7, wherein the duty controller includes a switching duty determining module performing pulse width modulation based on an output of the feed-forward controlling module.

9. The power supply device of claim 1, wherein the switching unit includes a first switching element and a second switching element, and
the first switching element and the second switching element are configured to alternately switch on or off, according to the control signal of the controlling unit.

10. A power supply device comprising:
a power supplying unit outputting first power and second power by switching input power; and
a controlling unit receiving a feedbacked output state of the first power to control switching of the power supplying unit in a first scheme, according to an output state of the second power, and receiving a feedbacked output state of the second power to control switching of the power supplying unit in a second scheme which is set differently from the first scheme.

11. The power supply device of claim 10, wherein the first power is secondary current information from the power supplying unit and the second power is secondary voltage information from the power supplying unit.

12. The power supply device of claim 11, wherein the first scheme is pulse frequency modulation and the second scheme is pulse width modulation.
